(19) United States
(12) Patent Application Publication
(10) Pub. No.: US 2007/0086528 A1
(43) Pub. Date: Apr. 19, 2007

(54) VIDEO ENCODER WITH MULTIPLE PROCESSORS

(76) Inventors: J. William Mauchly, Berwyn, PA (US); Joseph T. Friel, Ardmore, PA (US)

Correspondence Address: DOV ROSENFELD, 5507 COLLEGE AVE, SUITE 2, OAKLAND, CA, 94618, US

(21) Appl. No.: 11/539,514

(22) Filed: Oct. 6, 2006

Related U.S. Application Data
(60) Provisional application No. 60/813,592, filed on Oct. 18, 2005.

(51) Int. Cl. H04N 11/04; H04N 7/12

(52) U.S. Cl. 375/240.24; 375/240.26

(57) ABSTRACT

A method and system is described for video encoding with multiple parallel encoders. The system uses multiple encoders which operate in different rows of the same slice of the same video frame. Data dependencies between frames, rows, and blocks are resolved through the use of a data network. Block information is passed between encoders of adjacent rows. The system can achieve low latency compared to other parallel approaches.

### RELATED PATENT APPLICATION(S)

The present invention claims priority of, and is a conversion of U.S. Patent Provisional Application No. 60/813,592 filed Oct. 18, 2005 to inventors Mauchly et al. titled VIDEO ENCODER WITH MULTIPLE PROCESSORS. The contents of such U.S. Patent Provisional Application No. 60/813,592 are incorporated herein by reference:

### TECHNICAL FIELD

This disclosure relates in general to compression of digital visual images, and more particularly, to a technique for sharing data among multiple processors being employed to encode parts of the same video frame.

### BACKGROUND OF THE INVENTION

Video compression is an important component of a typical digital television system. The MPEG-2 video coding standard, also known as ITU-T H.262, has been surpassed by new advances in compression techniques. In particular, a video coding standard known as ITU-T H.264 and also as ISO/IEC International Standard 14496-10 (MPEG-4 part 10, Advanced Video Coding or simply AVC) compresses video more efficiently than MPEG-2. For example, typical video can be compressed using H.264 with the same perceived quality but at about one-half the bit-rate of MPEG-2. This increased compression efficiency comes at the cost of more computation required in the encoder. The construction of a high-definition video encoder that operates in real-time can require more than twenty billion compute operations per second. Even as faster processors become available, more computation can be applied to achieve even better compression.

It is desirable to construct a video encoder using an array of programmable processors. The mapping of this complex encoding algorithm onto a potentially large number of devices requires that the problem be broken up into pieces. We call this mapping a parallelization scheme.

An obvious parallelization scheme is to allow each processor to encode a different frame. This scheme is limited by the fact that each frame (except I-frames) needs to refer to previously encoded pictures, which are called reference frames. This limits the number of parallel processes to two or three.

A better parallelization scheme will permit many processors to be performing the same algorithm on different parts of the video picture. However, this approach is potentially much more complicated in H.264 compared to MPEG-2. This is because individual macroblocks in the same frame have several serial dependencies. For example, with H.264, macroblock number 2 cannot be fully encoded into the bitstream without information about how macroblock number 1 was encoded. These dependencies will be described in greater detail in the Description of Example Embodiments Section below.

The H.264 standard allows that a single video frame can be divided into any number of regions called slices. A slice is a portion of the total picture; it has certain characteristics precisely defined in H.264. The macroblocks in one slice are by definition never serially dependent on macroblocks in another slice of the same frame. This means that separate processors can encode (or decode) separate slices in parallel, without the dependency problem. Slice-level parallelism is common in MPEG-2 and is the obvious choice for H.264 encoder designs that use multiple processors. Unfortunately theses intra-macroblock dependencies are also the source of much of the strength of the H.264 standard. Putting many slices in the picture will cause the bitrate to grow by as much as 20%.

Attempts have previously been made to use multiple encoder in video compression. FIG. 1 shows a basic block diagram for the use of multiple encoders to encode a single video stream, and many prior art systems follow the general block diagram of FIG. 1. While an embodiment such as FIG. 1 is in general prior art, some embodiments of the present invention include a plurality of encoders working in parallel, and in that context the architecture of FIG. 1 is not prior art. An uncompressed digital video stream 25 enters a video divider 110. Each video frame is divided or demultiplexed so that a different part of the video frame goes to each encoder 100. Shown are four encoders 100, further labeled E1, E2, E3, and E4. These encoders 100 operate independently to each produce a compressed bitstream representing their portion of the frame. A bitstream mux 111 collects the outputs of the parallel encoders, and buffers them as necessary. The mux 111 then emits a single serial bitstream 55 which is the concatenation of the encoders outputs.

FIG. 2 describes a spatial arrangement of parallel encoders, and is applicable to some prior art methods and systems. In FIG. 2, a video frame is divided into macroblocks of 16 by 16 pixels. Groups of macroblocks are separated into slices 32 by slice boundaries 33. Each encoder 100 (E1, E2, E3, E4) is assigned to one of the slices. The encoders process the macroblocks inside the slice boundaries in a left-to-right, top-to-bottom pattern. During this process there is no synchronization between the encoders. Each encoder will typically take the full allotted time, that is the duration of one video frame, to complete the slice.

While en embodiment such as FIG. 2 is in general prior art, some embodiments of the present invention include a plurality of encoders working in parallel, and in that context what is shown in FIG. 2 may not be prior art.

Use of multiple parallel encoders for such compression application was proposed for constructing high-definition MPEG-2 encoders out of several standard-definition encoders. U.S. Pat. No. 5,640,210 to Golin et al., for example, discloses a coder/decoder architecture that divides a signal into “stripes” for individual processing. Every stripe is restricted to being a single row of macroblocks and a self-contained slice. This approach, if applied to H.264 instead of MPEG-2, would result in so many slices that the bitrate would be badly compromised. Note that the Golin et al. patent does, however, cite the need for the sharing of reference data between parallel encoders.

U.S. Pat. No. 6,356,589 to Gebler et al. titled “Sharing Reference Data Between Multiple Encoders Parallel Encoding a Sequence of Video Frames” discloses a general framework of using multiple encoders to process different parts of a video frame. It does not deal with any intra-macroblock dependencies, as it is directed at MPEG-2 encoders and was developed before H.264 was common or standardized. As with the Golin et al. patent, each of the component encoders processes a different slice of the picture.

The paper “Implementation of H.264 Encoder on General-Purpose Processors with Hyper-Threading Technology” by Eric Q Li and Yen-Kuang Chen appeared in Proceedings of SPIE—Volume 5308, Visual Communications and Image Processing 2004, Sethuraman Panchanathan and Bhaskaran Vasudev, Editors, January 2004, pp. 384-395. It presents a software implementation of H.264, using multiple independent threads in a shared memory space. The Li and Kuang paper discloses processing different parts of the same video frame by different threads running on the same CPU. It recognizes the temporal synchronization problems caused by intra-macroblock dependencies. However it does not deal with the data sharing problems, as it assumes a shared data space between threads. The use of shared memory between physically separate processors is undesirable; it becomes inefficient and expensive as processors are added.

None of the cited prior art addresses the problem of reassembling the output of the multiple encoders into a single slice.

### SUMMARY

One embodiment of the invention is a video encoder system using multiple encode processors. One embodiment is applicable to encoding according to the H.264 standard or similar standard. One embodiment of the system can achieve relatively low latency and a relatively high compression efficiency.

One embodiment of the system is scalable. One embodiment allows setting different number of encode processors according, for example, to one or more of desired cost, desired resolution, and/or algorithmic complexity of encoding.

One embodiment of this invention can operate at relatively high resolution and retain the relatively low latency. Embodiments of the invention may be applicable for video-conferencing. Embodiments of the invention may be applicable for surveillance. Embodiments of the invention are applicable for remote-controlled vehicle applications.

One embodiment of the invention is a method for employing multiple processors in the encoding of the same slice of a video picture. One embodiment of the invention allows encoding relatively few slices per picture.

One embodiment of the invention is a method for processing a sequence of video frames. The method includes using a plurality of video encoders, using a video divider to send different parts of a video picture to different encoders, and using a combiner to amalgamate the data from the encoders into a single encoded bitstream. The method also includes sharing data between the encoders in such a way that each encoder, when encoding a macroblock, can access macroblock information about its neighboring macroblocks.

One embodiment of the invention is an encode system that includes a first encode processor and a second encode processor. The first encode processor is coupled to the second processor. In one embodiment, the coupling is via network, and the first encoder sends certain macroblock information to the second processor via the network. In another embodiment, the coupling is direct, i.e., not via a network. In both embodiment, this coupling is operable to enable information transfer between the first and second processors, and, for example, allows the second processor to access information that the first processor has recently created.

One embodiment of the invention is a method for employing multiple encode processors to encode a single slice of video data, by having the encode processors share certain macroblock information. This macroblock information can include one or more of modes, motion vectors, unfiltered pixels from the bottom of the macroblock, and/or filtered pixels from the bottom of the macroblock.

One embodiment of the invention includes a method for processing a sequence of pictures. The method includes using plurality of encoders to encode a sets of blocks of the sequence of pictures, each set being a number denoted M of one or more rows of blocks in a picture of the sequence of pictures, or each set being a number denoted M of one or more columns of blocks in a picture of the sequence of pictures, wherein the sets in a picture are ordered, and wherein the plurality of encoders are ordered such that a particular encoder operative to encode a particular set of blocks is followed by a next encoder in the ordering of encoders to encode the set of blocks immediately following the particular set of blocks in the ordering of the sets. The method further includes transferring block information between the encoders of the plurality of encoders such that the particular encoder can use information from an immediately preceding encoder in the ordering of encoders. In the case that there are more sets of blocks in a picture than there are encoders in the plurality of encoders, the ordering of encoders is circular, such that the first encoder is preceded by the last encoder in the ordering.

In one embodiment of the method, each set is a row of blocks of image data. In a particular embodiment, the output of the particular encoder and the encoder immediately following the particular encoder are combined such that the particular set and the immediately following set of blocks are encoded into the same slice.

One embodiment of the invention includes an apparatus comprising a video divider operative to accept data of a sequence of pictures and to divide the accepted data into sets of blocks of the sequence of pictures, each set being a number denoted M of one or more rows of blocks of a picture of the sequence of pictures, or each set being a number denoted M of one or more columns of blocks in a picture of the sequence of pictures. The apparatus further comprises a plurality of encoders coupled to the output of the video divider, each encoder operative to encode a different set of blocks, wherein the sets in a picture are ordered, and wherein the plurality of encoders are ordered such that a particular encoder operative to encode a particular set of blocks is followed by a next encoder in the ordering of encoders to encode the set of blocks immediately following the particular set of blocks in the ordering of the sets. Each encoder is coupled to the encoder immediately preceding in the ordering, such that a particular encoder can use block information from an immediately preceding encoder in the ordering of encoders. In the case that there are more sets of blocks in a picture than there are encoders in the plurality of encoders, the ordering of encoders is circular, such that the first encoder is preceded by the last encoder in the ordering.

One embodiment of the apparatus further includes a combiner coupled to the output of the encoders and operative to receive encoded data from the encoders, and to combines the encoded data into a single compressed bitstream.

In one embodiment, each encoder includes a programmable processor and a memory, the memory operative to store at least the block information received from the encoder that is immediately preceding in the encoder ordering.

One embodiment of the invention includes a method comprising using a plurality of encoders to operate on different rows of the same slice of the same video frame, wherein data dependencies between frames, rows, and/or blocks are resolved by passing data between different encoders, including passing block information between encoders of adjacent rows. In one embodiment, the data is passed using a data network.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### BRIEF DESCRIPTION OF THE DRAWINGS

FIG. 1 shows a block diagram applicable to some prior art systems.

FIG. 2 shows macroblock encoding pattern used in some prior art systems.

FIG. 3 shows a macroblock encoding pattern that is usable in an embodiment of the present invention.

FIG. 4 shows a block diagram of an embodiment of the present invention.

FIG. 5A shows a neighbor block nomenclature used in an embodiment of the present invention.

FIG. 5B shows the neighbor block data dependency of an embodiment of the present invention.

FIG. 5C shows the range of the de-blocking filter in an embodiment of the present invention.

FIG. 6 is a flowchart for an encode process embodiment of the present invention.

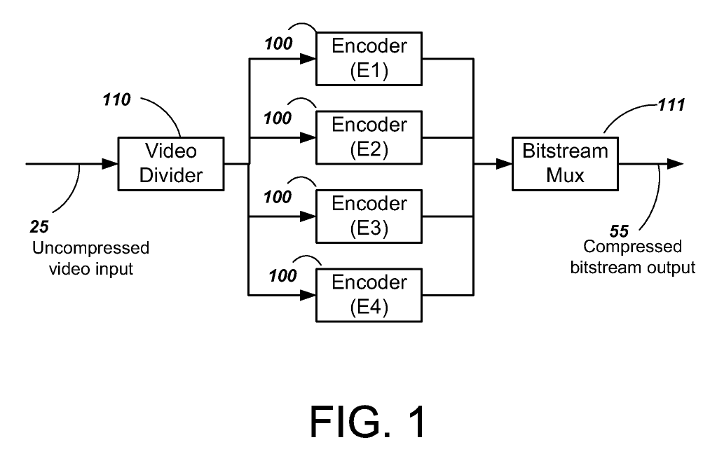

### DETAILED DESCRIPTION OF EXAMPLE EMBODIMENTS

The invention relates to video encoding. Some embodiments are applicable to encoding data to generate bitstream data that substantially conforms to the ITU-Y H.264 specification titled: ITU-T H.264 Series H: Audiovisual and Multimedia Systems: Infrastructure of audiovisual services—Coding of moving video. The present invention, however, is not restricted to this standard, and may, for example, be applied to encoding data according to another method, e.g., according to the VC-1 standard, also known as the SMPTE 421M video codec standard.

While those in the art will be familiar with the ITU-T H.264 standard, and other modern standards, such as the VC-1 standard, some details of H.264 are be provided herein for completeness.

H. 264 Advanced Video Coding

H.264 describes a standard for the decoding of a bitstream into a series of video frames. This decoding process is specified exactly, including the precise order of the steps involved. By this specification it is assured that a given H.264 bitstream will always be decoded into exactly the same video pictures.

The standard does not specify all the details of the encoding process. This fact allows for freedom in the design of the video encoder. There are considerable differences in the design and performance of various video encoders, whether implemented in hardware, software, or some combination. With the same video input, these different encoders will produce different encoded streams. It is the challenge of encoder designer to create an encoder that is efficient; that is, one whose output has both high fidelity to the original and a low bitrate.

The overall difference between H.264 and the earlier MPEG-2 is that it provides a great number of “tools.” The term tool herein means a distinct mathematical technique for manipulating the video data as it is being encoded or decoded. Some of the tools available in H.264 are:
Quarter-picture-element motion compensation.
Variable block-size motion compensation.
9 modes of intra prediction.
Context Adaptive Binary Arithmetic Coding.
Multiple reference frames.

The full list and the many details of these tools will not be listed here. Such details would be known to those in the art, and are not necessary for the understanding of the present invention. The careful integration of all these tools has been the result of many years of intense research by an international team of experts. We point out, then, that the construction of a fully functional H.264 encoder is a very complicated task. The techniques disclosed herein might be implemented as part of implementing a complete encoder, or may be used when one already has a functional encoder algorithm to start with.

By one of example, the one embodiment is explained herein related to certain H.264 tools in as much as they pose implementation problems to a system designer. In particular, one example addressed herein is using a number of discrete processors to encode a single video sequence.

General Data Flow of one Example

The example described herein is of encoding of a single video stream into a single compressed bitstream. Multiple processors are employed, in order to bring a great amount of computational power to the task.

The processors are assumed to be, but are not restricted to be, programmable computers. In some embodiments, each of the processors performs a single function, and can be referred to by the name of that function. Thus a processor performing the Video Divider task is denoted be called the Video Divider, and so forth. There are some number of encoders, which are denoted herein by E1, E2, E3, and so forth. The number of encoders is denoted by N. In the example described herein, N=4, unless otherwise specified. Some of the description, for example, is for N=2 but can be generalized to any N≧2. In practice, those in the art will understand that the number of encoders used depends on the resolution of the video, the computational power of the processors, and so forth. It is conceivable that 15 encoders or more might be used in some applications, less in others.

Each video frame is divided into what are called macroblocks in the H.264 standard, e.g., 16 by 16 pixel blocks. The macroblocks are grouped into sets that either are each a row or each a column. In the description herein, the case of grouping into rows is described, because the data is assumed to arrive video row by video row, so that less buffering may be required when processing in rows. Those in the art will understand that other embodiments assume sets that are each a column. Furthermore, it also is possible to arrange the macroblocks such that each set is a plurality of rows of macroblocks, or such that each set is a plurality of columns of macroblocks. However, rather than in terms of “sets” of macroblocks, the description is mostly written in terms of rows of macroblocks.

The encoders are ordered. Typically, but not necessarily, there are more than N rows of macroblocks in a picture, and the ordering of encoders is circular, such that the first encoder is preceded by the last encoder in the ordering of encoders.

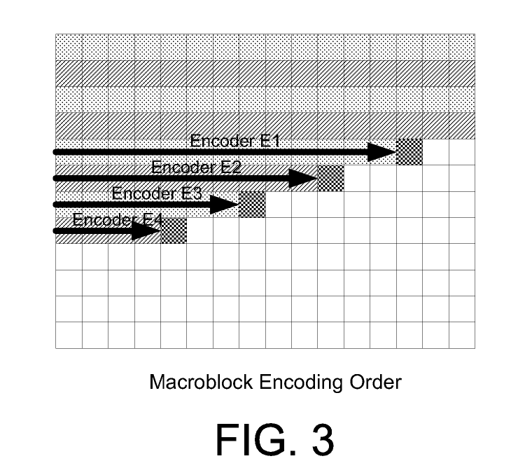

In one embodiment, the rows are encoded in adjacency order, by assigning the encoders 100 to the adjacent rows, e.g., in sequentially numbered rows according to sequential numbering of the rows, i.e., one adjacent row after another. This arrangement is shown in FIG. 3. Thus, in one embodiment adjacent rows (in general rows or columns) are assigned to different encoders.

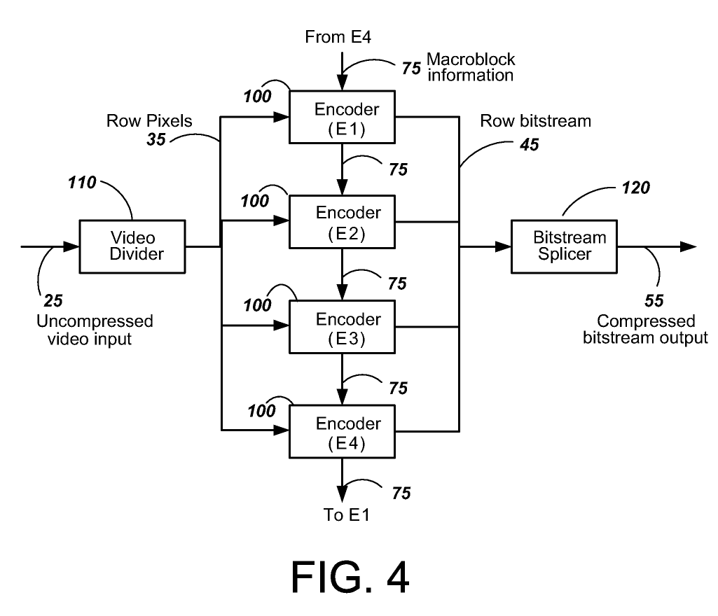

The basic data flow of one embodiment of a method is described by referring to FIG. 4 that shows an example encoder apparatus to process video input information. In one embodiment, the video information is provided in the form of 8-bit samples of Y, U, and V. The encoder apparatus includes a Video Divider 110 and the video information is first handled by the Video Divider 110. The video input information for a frame is assumed to arrive in raster order; in a line from left to right; lines running top to bottom. Video processing occurs on groups of 16 lines called macroblock rows (MB-rows). Note that throughout this disclosure, “MB” denotes a macroblock. The Video Divider 110 divides the frame into MB-rows and distributes different MB-rows to different ones of the plurality of encoders 100. The example apparatus shows four encoders 100, and those in the art will understand that the invention is not restricted to such a number of encoders 100. Each encoder 100 compresses a respective MB-row video input and produces a respective Row Bitstream 45. The encoder apparatus includes a combiner, called a Bitstream Splicer 120 operative to receive row bitstreams 45 from the individual encoders 100, and to combines them into a single compressed bitstream output 55.

During the encoding of a row, the encoders 100 also transfer data to one another. There thus is a data path for Macroblock Information 75 from one encoder of the plurality of encoders 100 to another encoder. Each encoder transfers data to the encoder below, i.e., the next set of macroblocks, and the last encoder has a path also shown as path 75, this time back to the top from E4 to E1 in the four-encoder example of FIG. 4. In one embodiment, after every macroblock is encoded, a particular encoder processing a particular MB-row transmits a small packet of data, in one embodiment approximately 200 bytes, via path 75 to the encoder that is processing the MB-row immediately following the particular MB-row of the particular encoder in the picture. This packet of data in one embodiment is delivered in a low-latency path 75 because the receiving encoder will need this information to encode the macroblock below. The nature of this Macroblock Information, called MB-information, is explained below.

The coupling between the processors is in one embodiment direct, and in another embodiment, via a network, e.g., a Gigabit Ethernet. One direct coupling uses a set of one or more bus structures.

Spatial Arrangement and Scanning Order

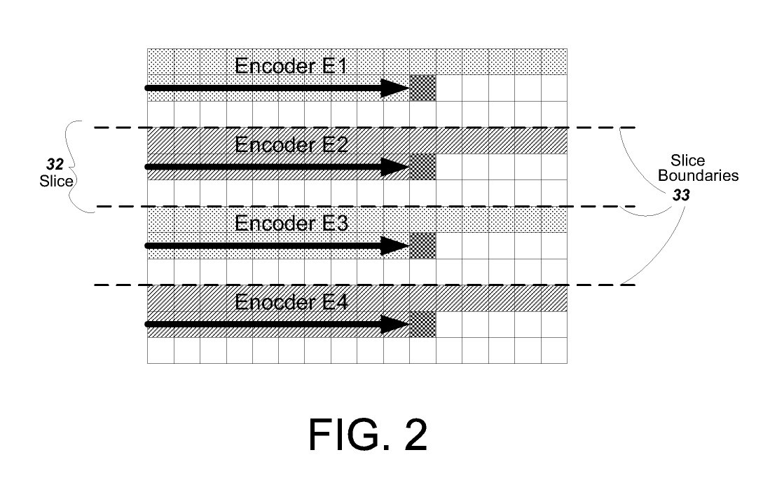

As shown in FIG. 2, in some prior art systems, only a single encoder is used in each slice. If more encoders are needed to speed the process, then in some prior art systems, the input picture is divided into more slices. The use of more slices may have a detrimental effect on the quality of the picture.

FIG. 3 shows a pattern in which encoders are allocated to rows in an embodiment of the current invention, in the example of four encoders. In FIG. 3, all four encoders encode adjacent rows that are all in the same slice. The entire picture can, for example, be a single slice.

In one embodiment, video data is assigned to the multiple encoders sequentially, so that adjacent MB-rows go to “adjacent” encoders. In one embodiment, the encoders process the rows sequentially and each encoder produces a Row Bitstream Output 45. Referring to FIG. 3, the first encoder, shown as E1, processes, for example, the first row and produces a Bitstream Output 45 which represents just that row. When E1 is done with the first row, it starts on the fifth row, since rows 2, 3, and 4 are already being encoded by the encoders respectively denoted E2, E3, and E4. Each encoder, when done processing a row, starts on the next available row, which will always be N rows ahead for the case of N encoders. Referring again to FIG. 3, suppose the four encoders process rows 5,6,7, and 8. As they finish those rows the four encoders proceed to encode rows 9, 10, 11, and 12, respectively.

Note that while, for simplicity, FIG. 3, shows 12 MB-rows, in actual video material, there are usually many more. Standard definition 720×480 video, for example, has 30 MB-rows; high definition 1280×720 video, for example, has 45 MB-rows, and so forth.

If there are no more uncoded rows in a frame, then an encoder completing its processing of a row moves on to the next available row in the next frame of video to be encoded. In one embodiment, it is not necessary that the first encoder (E1 of FIG. 3) process the first line; any encoder may be assigned to the first MB-row of a particular frame. Such an embodiment provides an advantage over other schemes that rely on dividing the frame equally between a plurality of encoders. For example, consider a video picture of 45 macroblock rows, and an encoding apparatus with 10 encoders. The sixth encoder encodes rows 6, 16, 26 and 36. When it is done row 36, there is no row 46, so it moves on to row 1 of the next frame.

The improved scanning order has advantages over the prior art. It eliminates any requirement to divide the picture into slices, yet at the same time allows more flexibility on the size of slices if they are desired. The processing arrangement will also allow for very low latency encoding. However the improved scanning order introduces data dependencies between the encoders. The current invention addresses these data dependencies, making the improved scanning order practicable.

Spatial Data Dependencies

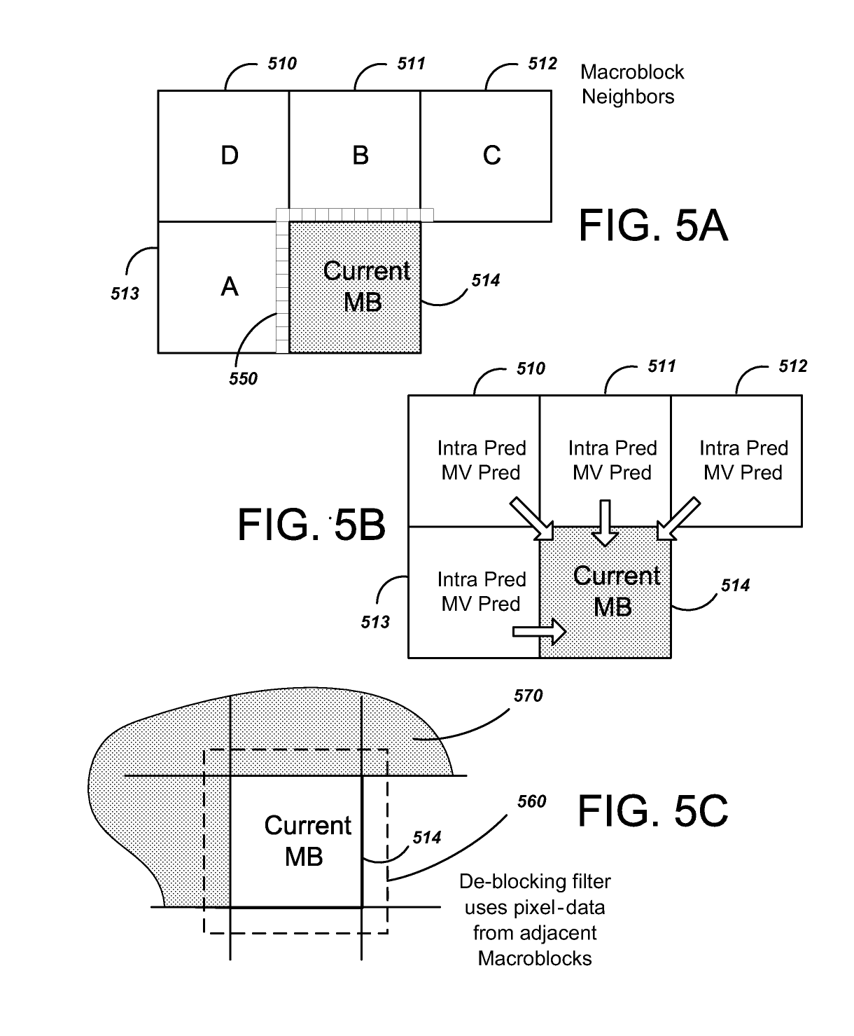

FIG. 5A illustrates the nomenclature for neighbour macroblocks (MBs), that, in general, is consistent with the nomenclature used in the H.264 standard.

FIG. 5A shows the “current MB” 514. The MB to the immediate left of the current MB is labeled “A” 513. The MB directly above is labeled “B” 511, and the two MBs diagonally above the current MB are respectively labeled “C” 512 and “D” 510.

As shown in FIG. 5B, information from the neighbor blocks is needed to correctly encode or decode the current MB. The encoding mode of each neighbor block must be known. The final coded values of motion vectors of each neighbor block must be known. For example, the motion vector value encoded in the bitstream is the difference between the actual motion vector and the predicted motion vector, which is the median of the motion vectors in the A, B, C, and D blocks.

Referring to FIG. 5A again, when Intra prediction is used, the pixel values of the current MB are copied or derived from pixels that surround it on two sides 550. The already coded pixels are used, not the source pixels, so the neighbor blocks must have been completely coded and then reconstructed by the encoder before the current MB can be coded.

The H.264 standard defines a de-blocking filter that can affect every pixel in a frame. The filter is also called a “loop” filter because it is inside the coding loop. FIG. 5C shows the pixel dependency when such a loop filter is used. The pixels in a macroblock 514 will be affected by, and will affect, the neighboring pixels on all sides of the MB 560. The filtering operation runs across vertical and horizontal macroblock edges and must be done in a precisely described order. The order is such that when filtering the current MB 514, the filter will need as input already-filtered pixels 570 from the neighboring MBs. Thus the de-blocking filter creates another data dependency between macroblocks.

Serial Data Dependencies

As in MPEG-2, the quantization value, denoted QP in a H.264 macroblock is encoded as a difference, (called deltaQP), of the previous quantization value. This creates a serial dependency of each block on the previous block in the slice. Note that for the blocks along the left edge of the picture, the previous macroblock is the last block of the previous row. This block is not spatially adjacent. In the encoder system described herein, the block on the left edge is actually encoded before the last block on the previous row is encoded. This means that it is impossible to encode deltaQP at that point in time. It will be shown that the Bitstream Splicer 120 will deal with this problem.

A second serial data dependency designed into H.264 is the skip run-length. Briefly, in one embodiment of a H.264-compliant encoding apparatus, a skipped macroblock does not use any bits in the bitstream; a matching decoder infers the mode and the motion vector of the block from its neighbors. Only the number of skipped blocks between two coded blocks, called the “skip run-length,” is encoded in the bitstream for skipped macroblocks. Since the run of skipped blocks can extend from the end of one row into the beginning of the next row, one embodiment of the row-based encoder method or apparatus described herein also needs to take this into account. An encoder should not need to know how many skipped blocks are at the end of the previous row at the time it starts a new row.

Reference Data Dependency

Reference frames are previously encoded/decoded frames used in motion prediction. In H.264, any encoded frame can be deemed a reference frame. Multiple encoders may need to share reference frames.

Note that the problem of sharing reference frames among parallel encoders has been explored in the context of MPEG-2. Cited U.S. Pat. No. 5,640,210 by Golin et al. and U.S. Pat. No. 6,356,589 by Gebler et al. teach reference frame sharing methods.

Resolution of Data Dependencies

In summary, to encode a macroblock in H.264, the encoder must have the following data available:
The source pixels to be encoded.
The reference pixels from previously encoded reference frames.
Motion vectors and other macroblock mode information from neighbors A, B, C, and D.
Coded but unfiltered pixels 550 that abut the current MB from A, B, C and D.
For the loop filter (de-blocking filter) to be computed on a macroblock by macroblock basis, partially filtered pixels from A, B, C and D are also required.
The QP of the last coded block.
The skip run-length since the last coded block.

The H.264 bitstream was designed to be encoded and decoded in macroblock order. The design of H.264 supports parallelism at a slice level. Embodiments of the present invention describe parallelism, e.g., use of multiple encoding processors within a slice.

Macroblocks within a slice have multiple dependencies, both spatial and serial. In the case of only a single processor and a large data space available, the results of each coding decision, such as the motion vector, are simply stored in an array that can be randomly accessed as needed. In the case of two encoders that can share such an array, there are no data access problems, but there will be synchronization issues. Embodiments of the present invention include the case of two or more encoders, even where there is no shared memory. A communication scheme is included for sharing the required information and for handling synchronization issues. Embodiments of the present invention, for example, can deal with the data dependency problem encountered when two or more encoders encode macroblocks in the same slice.

As shown in FIG. 4, needed data is made available to each encoder 100 in the following ways:
Source pixels 35 are provided by the video divider 110, so each encoder only handles the rows of pixels that it needs;
Reference pixels are shared by each encoder 100 so that the reference picture pixels are available to every other encoder when future frames are encoded;
Motion vectors, other macroblock mode information, unfiltered edge pixels, and partially filtered reference pixels are stored in a MB-info structure as each block is encoded. The MB-info for each block is transmitted to the encoder that is encoding the following adjacent row. This transfer happens via path 75 per macroblock, as soon as the macroblock is finished being coded;
The QP and skip run-length at the beginning and end of each row are recorded in a Row-info structure, and this information is transmitted 45 to the bitstream splicer at the completion of each row; and
The final output bitstream of a row is transmitted 55 from the bitstream splicer at the end of each row.

The spatial dependency is thus accommodated by the transfer of MB-info from one encoder to another. A link is provided from one encoder to the next encoder for one encoder to send MB-info to the encoder of the following row. The link in one embodiment is direct, and in another embodiment, is via a data network such as a Gigabit Ethernet. When this next encoder receives the MB-info, such next encoder stores the received MB-info in a local memory of the next encoder. Thus each encoder 100 includes a local memory. This next encoder also has stored in its local memory previously received MB-info from the row above. When the second encoder needs MB-info for neighbor blocks B, C, or D, such information is available in local memory. In one embodiment, a left-to-right processing order of the rows is used, and the newly received MB-info is first required as the “C” neighbor (above and to the right). The MB-info of older blocks B and D will have already been received and will also be in local memory.

An Encoding Method using a Plurality of Encoders

FIG. 7 depicts a flowchart of one embodiment of an encoding method using a plurality of encoders, and is the method that is executed at each encoder 100. In one embodiment, each encoder includes a programmable processor that has a local memory and that executes a program of instructions (encoder software). The flowchart shown in FIG. 7 is of the top-level control loop in the encoder software. Briefly, each encoder 100 synchronizes to incoming pixel data at the start of a row, and synchronizes to incoming macroblock information at the start of each macroblock. In more detail, the method proceeds as follows.

The encoder 100 initializes its internal states and data structures in 708.

The encoder in 710 reads configuration parameters which include the picture resolution, frame rate, desired bitrate, number of B frames and number of rows in a slice.

The encoder in 712 gets Sequence Parameters and creates the Sequence Parameter Set.

The row process now begins. The encoder 100 in 714 acquires a complete row of MB data, e.g., the YUV components. In one embodiment the encoder 100 actively reads the data, and in an alternate embodiment, the apparatus delivers the data via DMA into the encoder processor's local memory. In one embodiment, a complete row of data is received before the process proceeds.

In 716 the Encoder 100 ascertains if this is the first row in the slice. If so, the encoder 100 in 718 produces a slice header then proceeds to 720, else the encoder proceeds to 720 without producing the slice header.

In 720, the row QP and the skip run-length are initialized as this is the beginning of a row.

In 722 it is ascertained if the neighbor “C” exists (see FIG. 5A), and if so, then in 724, the encoder waits for the MB-info of the preceding row to arrive from another encoder—the encoder of the preceding row. That is, if this is not the top row of a picture, the encoder waits for data from the row above.

In 726 the encoder decides the macroblock Mode. This typically includes motion estimation, intra-estimation, also called intra-prediction, and detailed costing of all possible modes to reach a decision as to what mode will be most efficient. How to carry out such processing will be known to those in the art for the H.324 standard (or other compression schemes, if such other compression schemes are being used). From 726 will be known, for example, whether the block will be coded, uncoded, or skipped.

In one embodiment, the macroblock information includes motion vectors, such that the encoder is able to perform motion vector prediction.

In one embodiment, the macroblock information includes unfiltered edge pixels, such that the encoder is able to perform intra prediction.

If the block is coded in 726, and the QP is coded, in 728 it is ascertained if this is the first coded QP in the row, and if so, in 730, then the QP and the bit-position in the output bitstream are recorded in the Row-info structure.

In 732 the encoder produces coefficients and reconstructs pixels per the compression scheme and generates the variable length code(s) (VLC). In more detail, these operations use the decisions made in step 726 to reconstruct the macroblock exactly as a decoder will do it. This gives the encoder an array of (unfiltered) reference pixels. If the block is not skipped, the encoder also performs the variable length encoding process to produce the compressed bitstream representing this macroblock. The macroblock is now finished being encoded.

In one embodiment, the macroblock information includes unfiltered or partially-filtered edge pixels, such that the encoder is able to perform pixel filtering across horizontal macroblock edges.

734 includes ascertaining whether this row is the last row of the picture. If not, then in 736, the encoder passes the MB-info to the encoder of the next row, e.g., via the link 75 which in one embodiment is a network connection.

738 includes ascertaining whether the macroblock is the last MB in the row to see if this is the end of the macroblock processing loop. If there are more macroblocks in the row, the loop continues with 722 to process the next macroblock in the row. If indeed there are not more MBs in the row, the processing continues at 740 for the “end-of-row” processing.

In 740, the encoder stored the current QP and Skip run-length in the Row-info data structure.

In 742, the encoder provides the row bitstream 45 for the row to the bitstream splicer 120, and in 744, the encoder provides the row info also to the bitstream splicer 120.

In 746, the encoder passes the output reference pixels to the other encoder(s) via path 75. The encoder is now ready to process the next row starting at 714.

Bitstream Splicer 120

The encoding apparatus includes the Bitstream Splicer 120 shown in the 4-encoder example of FIG. 4. The Bitstream Splicer 120 receives the outputs 45 of the multiple encoders 100 and combines them into a single bitstream 55 which is H.264 compliant. One in the art will understand how to so combine a plurality of items of information from the following description of one embodiment of a process of combining two rows into one slice.

The combining process includes the Bitstream Splicer 120 receiving the Row-info for the current row and receiving the Row-bitstream for the current row. The process further includes computing the delta-QP value for the first coded block in the current row using the last coded QP value of the previous row, encoding the delta-QP value in the bitstream, computing the skip run-length, e.g., by adding the skip run-length from the previous row to the skip run-length of the current row, encoding the skip run-length in the bitstream, and performing a bit-shift operation on bitstream data of the current row so that it is concatenated with the bitstream data of the previous row. Thus, in one embodiment, the combiner 120 includes a bit shifter. Thus, in one embodiment, the combining of the encoder outputs includes the computation and encoding of a quantization level difference. Also, in one embodiment, the combining of the encoder outputs includes the computation and encoding of a macroblock skip run-length. Furthermore, in one embodiment, the output of the encoder immediately following a particular encoder is a bitstream, and the combining of the bitstream of the particular encoder and of the following encoder includes a bit-shift operation on the bitstream.

In the case that the current row is the end of the slice, the process further includes terminating the slice bitstream by padding out with zero bits until the bitstream ends on a byte boundary.

Encoder Processors and Data Networks

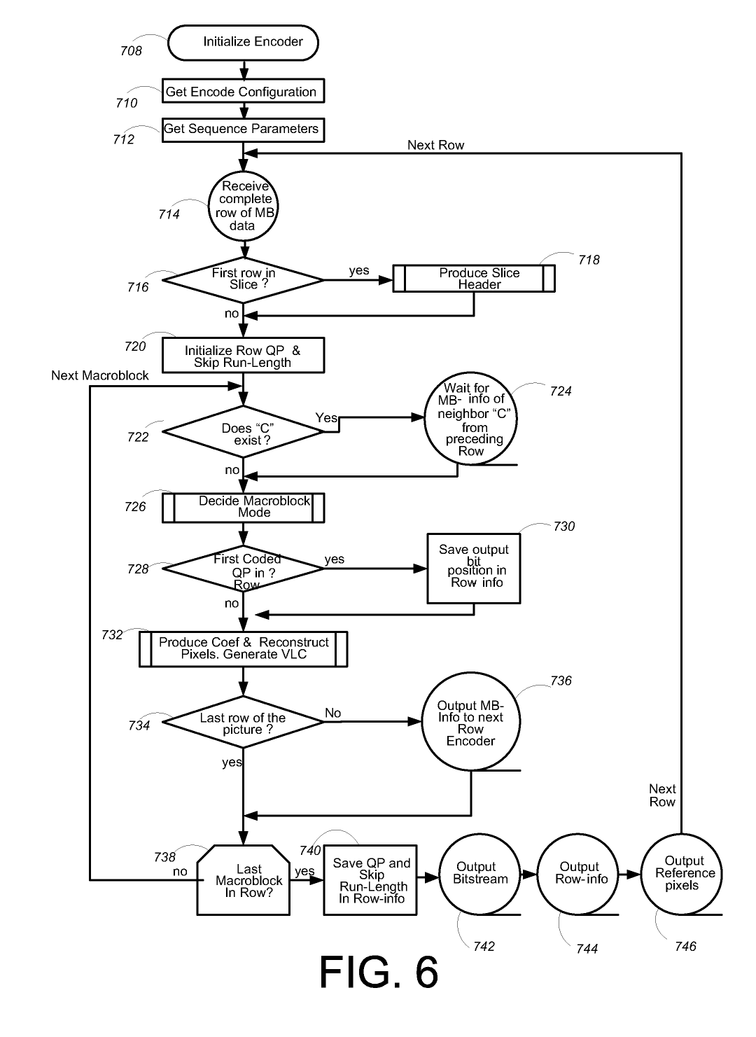

In one embodiment, the encoding processors are each a processor that includes a memory, e.g., at least 64 Megabytes of memory, enough to hold all the reference pictures, and a network interface to a data network, e.g., to a gigabit Ethernet and a high-speed Ethernet network switch. Of course, the processors each also include memory and/or storage to hold the instructions that when executed carry out the encoding method, e.g., the method described in the flow chart of FIG. 6, including the H.264 encoding of the macroblocks. In one embodiment, the encode processors communicate to each other over the data network via their respective network interfaces.

In an alternate embodiment, the encoding apparatus includes data links 75 between encode processors that are direct, e.g., data buses specifically designed to pass the data required for the described encode tasks. In one such embodiment with non-network connection between encoders I 00, the transfer of input data, output data, reference data, and macroblock information occur on separate buses. Each bus is arranged based on the latency and bandwidth requirements of the specific data transfer.

Thus, an encoding apparatus that includes multiple encoders has been described. Also an encoding method that uses multiple encoders has been described. Furthermore, software for encode processors that work together to encode a picture has been described, e.g., as logic embodied in a tangible medium for execution that when executed, carry out the encoding method in each of a plurality of the encode processors that communicate to pass data.

Many other variations are possible. For example, those in the art will understand that the method and apparatus described herein can be applied to other compressions methods, and or other standards for video compression. For example, the method described herein is readily modifiable to operate to produce a compressed bitstream that conforms to the VC-1 standard. Furthermore, many types of links are possible between the individual encode processors, and those in the art will understand how to modify the description herein to so modify different link types.

Furthermore, while embodiments have been described in which the individual encoders 100 are each a programmable processor running software, an apparatus can be built to implement what is described herein using encoders that use special-purpose hardware, or alternately, encoders that use a combination of special purpose hardware and software.

Furthermore, while the processing is described herein in which data is assumed to arrive in rows (or alternately in columns) one after the other, or one macroblock's worth of rows after another, and each encoding element processes a single set of macroblocks, which can be either a single row, or even a single column, and communicates to the processor that will process the next row of macroblocks, several variations are possible in this arrangement. First, as already mentioned, while data arriving row by row is most common, it is conceivable to process in columns rather than rows, and the description herein is meant to cover such a variation. Furthermore, it may be that each processor processes more than a single row of macroblocks at a time, e.g., two rows of information, and uses information from the row of macroblocks immediately preceding the plurality of rows. If each encode processor processes a number denoted M of rows, and there are N encode processors, than the next time an encode processor processes data, it will skip MN macroblock rows (modulo the number of rows in a picture) to obtain the next data to encode. Thus many variations are possible.

Another alternate embodiment includes more than one macroblock in each set of macroblocks, e.g., than one macroblock in each row, are encoded by a respective plurality of encoders working in parallel. Using the case of more than one macroblock of a row processed by more than one encoder working in parallel, this is equivalent to having a larger encode processor that in structure includes the plurality of encoders that operate on the macroblock of the same row, and having a “supermacroblock” that includes the macroblock being worked on in parallel. Hence, such an alternate embodiment is converted, e.g., by FIG. 4 and FIG. 6, but with changes to account for encoding supermacroblocks of several macroblocks, and taking into account how the individual macroblocks in the supermacroblock effect each other.

Note further than, to be consistent with the terminology used in the H.264 standard, the term macroblock is used. In general, e.g., in the claims, the term “block” is used to indicate that some features of embodiments of the invention are applicable to sets of a row or column of blocks of image data, not just macroblocks as defined in H.264. Therefore, MB-info is in general block information, and so forth.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors, e.g., one or more processors that are part of an encoder of picture data. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It should further be appreciated that although the invention has been described in the context of ITU-H.264, the invention is not limited to such contexts and may be utilized in various other applications and systems, for example in a system that uses VC-1, or other compression methods. Furthermore, the invention is not limited to any one type of network architecture and method of communication between the multiple encoders, and thus may be utilized in conjunction with one or a combination of other network architectures/protocols.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. A method for processing a sequence of pictures comprising:
using plurality of encoders to encode a sets of blocks of the sequence of pictures, each set being a number denoted M of one or more rows of blocks in a picture of the sequence of pictures, or each set being a number denoted M of one or more columns of blocks in a picture of the sequence of pictures, wherein the sets in a picture are ordered, and wherein the plurality of encoders are ordered such that a particular encoder operative to encode a particular set of blocks is followed by a next encoder in the ordering of encoders to encode the set of blocks immediately following the particular set of blocks in the ordering of the sets; and
transferring block information between the encoders of the plurality of encoders such that the particular encoder can use information from an immediately preceding encoder in the ordering of encoders,
wherein in the case that there are more sets of blocks in a picture than there are encoders in the plurality of encoders, the ordering of encoders is circular, such that the first encoder is preceded by the last encoder in the ordering.

2. A method as recited in claim 1, wherein each set is a row of blocks of image data.

3. A method as recited in claim 2, wherein the output of the particular encoder and the encoder immediately following the particular encoder are combined such that the particular set and the immediately following set of blocks are encoded into the same slice.

4. A method as recited in claim 2, wherein the block information includes unfiltered or partially-filtered edge pixels, such that the encoders are able to perform pixel filtering across horizontal block edges.

5. A method as recited in claim 3, wherein the block information includes motion vectors, such that the encoders are able to perform motion vector prediction.

6. A method as recited in claim 3, wherein the block information includes unfiltered edge pixels, such that the encoders are able to perform intra prediction.

7. A method as recited in claim 3, wherein the combining of the encoder outputs includes the computation and encoding of a quantization level difference.

8. A method as recited in claim 3, wherein the combining of the encoder outputs includes the computation and encoding of a block skip run-length.

9. A method as recited in claim 3, wherein the output of the encoder immediately following the particular encoder is a bitstream, and the combining includes a bit-shift operation on the bitstream.

10. A method as recited in claim 3, wherein the block information includes motion vectors and also includes unfiltered edge pixels, and wherein the combining of the encoder outputs includes the computation and encoding of a quantization level difference and also includes the computation and encoding of a block skip run-length.

11. A method as recited in claim 3, wherein the transferring of block information between encoders is via a network.

12. A method as recited in claim 3, wherein the transferring of block information between encoders is via one or more bus structures.

13. A method as recited in claim 3, wherein the particular encoder when completing encoding a row of blocks next encodes the row that is N rows later, N being the number of encoders in the plurality of encoders, and wherein rows are orders such that last row of blocks in one picture is followed by the first row of blocks in the next picture in the sequence of pictures.

14. An apparatus comprising:
a video divider operative to accept data of a sequence of pictures and to divide the accepted data into sets of blocks of the sequence of pictures, each set being a number denoted M of one or more rows of blocks of a picture of the sequence of pictures, or each set being a number denoted M of one or more columns of blocks in a picture of the sequence of pictures; and
a plurality of encoders coupled to the output of the video divider, each encoder operative to encode a different set of blocks, wherein the sets in a picture are ordered, and wherein the plurality of encoders are ordered such that a particular encoder operative to encode a particular set of blocks is followed by a next encoder in the ordering of encoders to encode the set of blocks immediately following the particular set of blocks in the ordering of the sets; each encoder coupled to the encoder immediately preceding in the ordering, such that a particular encoder can use block information from an immediately preceding encoder in the ordering of encoders,
wherein in the case that there are more sets of blocks in a picture than there are encoders in the plurality of encoders, the ordering of encoders is circular, such that the first encoder is preceded by the last encoder in the ordering.

15. An apparatus as recited in claim 14, further comprising a combiner coupled to the output of the encoders and operative to receive encoded data from the encoders, and to combine the encoded data into a single compressed bitstream.

16. An apparatus as recited in claim 14, wherein each encoder includes a programmable processor and a memory, the memory operative to store at least the block information received from the encoder that is immediately preceding in the encoder ordering.

17. An apparatus as recited in claim 14, wherein the block information includes motion vectors and also includes unfiltered edge pixels, and wherein the combining of the encoder outputs includes the computation and encoding of a quantization level difference and also includes the computation and encoding of a block skip run-length.

18. An apparatus as recited in claim 14, wherein the transferring of block information between encoders is via a network.

19. An apparatus as recited in claim 14, wherein the transferring of block information between encoders is via one or more bus structures.

20. A system as recited in claim 15, wherein the combiner includes a bit-shifter.

21. A method comprising using a plurality of encoders to operate on different rows of the same slice of the same video frame, wherein data dependencies between frames, rows, and/or blocks are resolved by passing data between different encoders, including passing block information between encoders of adjacent rows.

22. A method as recited in claim 21, wherein the data is passed using a data network.
